(19) United States
(12) Patent Application Publication
(10) Pub. No.: US 2015/0163073 A1
(43) Pub. Date: Jun. 11, 2015

(54) MASSIVE MIMO CHANNEL ESTIMATION

(71) Applicant: Broadcom Corporation, Irvine, CA (US)

(72) Inventors: Nihar Jindal, San Mateo, CA (US); Arogyaswami Paulraj, Stanford, CA (US); Louay Jalloul, San Jose, CA (US); Sam Alex, Sunnyvale, CA (US); Amin Mobasher, Menlo Park, CA (US)

(21) Appl. No.: 14/142,654

(22) Filed: Dec. 27, 2013

Related U.S. Application Data
(60) Provisional application No. 61/914,900, filed on Dec. 11, 2013.

(51) Int. Cl. H04L 25/02; H04B 7/04

(52) U.S. Cl. CPC H04L 25/023; H04L 25/0204; H04B 7/0413

(57) ABSTRACT

In an embodiment, a method of channel estimation is provided. The method includes determining a parametric model for a channel between a first transceiver and a second transceiver and transmitting a pilot signal to the second transceiver. The receiving transceiver is configured to determine a parameter of the parametric model based at least on the pilot signal and to estimate a channel transfer function coefficient for the channel based on the parameter and the parametric model.

### CROSS REFERENCE TO RELATED APPLICATIONS

This application claims the benefit of U.S. Provisional Appl. No. 61/914,900, filed Dec. 11, 2013, which is incorporated by reference herein in its entirety.

### BACKGROUND

1. Field

The present disclosure generally relates to antenna methods and systems for Massive-Multi-Input-Multi-Output (M-MIMO) communication.

2. Background Art

In wireless communication systems, user equipment (UE), e.g., a mobile phone, accesses a network through an access point, such as a base station (BS). For example, in a cellular communication system, a geographic area can be divided into a number of cells, each having a BS. The radius of a cell is depends on several factors including the transmit power from the BS, propagation loss, etc.

Wireless communication systems have evolved to use multi-input-multi-output (MIMO) configurations. For example, in this implementation, the BS and/or the UEs can include arrays having a limited number of antennas, i.e., 2, 4, etc. A communication channel can be established between each antenna of the BS and each antenna of the UE. Each communication channel operates to transform transmitted symbols into different symbols that are eventually received. This channel transformation can be captured in a channel transform function coefficient. The channels from the BS to the UEs can be characterized by a matrix, H, of coefficients of size [n×m], where n is the number of antennas in the BS's antenna array and m is the number of antennas in the UE's antenna array.

Conventionally, the channel transform function matrix H is determined at a UE based on pilot signals that are transmitted by the BS. However, in massive-MIMO (M-MIMO) environments in which the BS has, e.g., 100 or more antennas, transmitting pilot signals from each antenna can result in a large overhead which if transmitted would reduce the peak data rate transmitted

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates a conventional massive multi-input-multi-output (M-MIMO) communications environment.

FIG. 2 illustrates a M-MIMO communications environment, according to an embodiment.

FIG. 3 shows a flowchart providing example steps for estimating a channel, according to an embodiment.

FIG. 4 illustrates an exemplary calibration of an antenna array, according to an embodiment.

FIG. 5 illustrates an exemplary dissemination of a parametric model, according to an embodiment.

FIG. 6 illustrates an exemplary antenna array, according to an embodiment.

FIG. 7 illustrates a M-MIMO communications environment, according to an embodiment.

FIG. 8 illustrates an exemplary transceiver, according to an embodiment.

The present disclosure will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

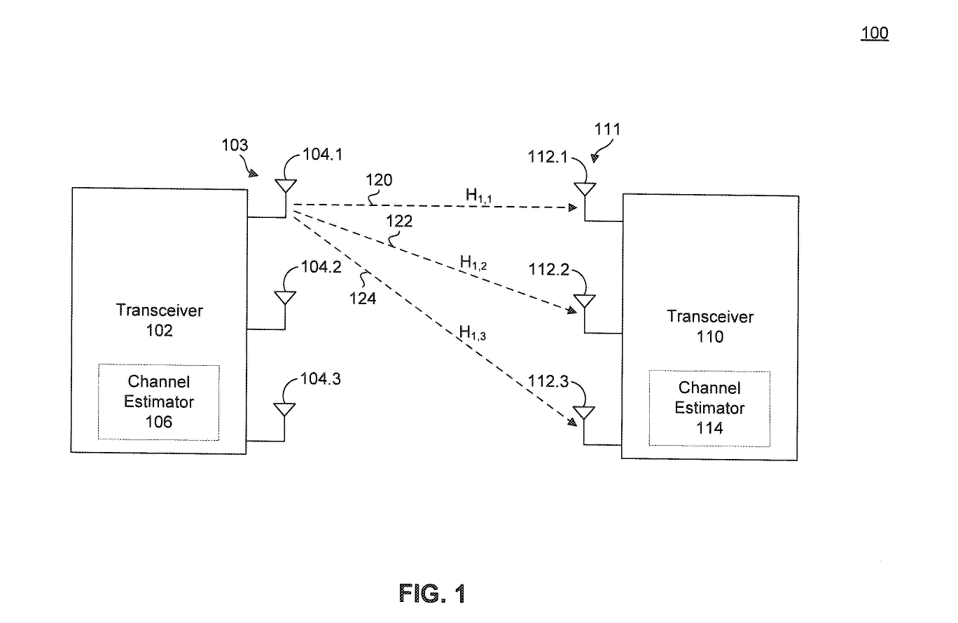

FIG. 1 illustrates an exemplary conventional operating environment 100 including transceivers 102 and 110. In one example, transceiver 102 can be a base station (BS) and transceiver 110 can be a user equipment (UE). Transceiver 102 communicates through an antenna array 103 including antennas 104.1, 104.2, and 104.3. Transceiver 110 communicates through an antenna array 111 including antennas 112.1, 112.2, and 112.3. As illustrated in FIG. 1, environment 100 is a multi-input-multi-output (MIMO) environment. For example, each of transceivers 102 and 110 can both transmit and receive using multiple antennas.

A communication channel is established between each antenna of the two transceivers involved in the communication. For example, in FIG. 1, antenna 104.1 of transceiver 102 has three channels, 120, 122, and 124, associated with it. Through the use of multiple channels, the effective data rate of communications between transceivers 102 and 110 can be greatly increased. For example, a given data stream can be separated over a number of different channels at transceiver 102 and recombined into one stream at transceiver 110. Thus, a high-rate data transfer can be implemented using a number of slower channels.

In general, a communication channel transforms a transmitted symbol into a symbol that is received at the receiver. This transform is captured using a channel transform function coefficient, which can be a complex number. For example, a received symbol, y, can be expressed as:

y=Hx+n, (Eqn. 1)

where

x is the originally transmitted symbol,

H is the channel transform function coefficient for the channel, and

n is a value indicative of the noise in the channel (e.g., which can be modeled as Gaussian white noise).

For example, in FIG. 1, communication channels 120, 122, and 124 transform transmitted symbols according to channel transform function coefficients H_{1,1}, H_{1,2}, and H_{1,3}, respectively. More generally, the communication from transceiver 102 to transceiver 110 can be characterized by a channel transform function matrix, H, with each value in the matrix capturing the transform applied by that respective communication channel to transmitted symbols. (In the example of FIG. 1, matrix H is a three-by-three matrix.) A vector of received symbols, y, can be expressed as:

y=Hx n, (Eqn. 2)

where:

x is a vector of the originally transmitted symbols, and

n is a vector of values indicative of the noise in the respective channels.

As shown in FIG. 1, transceivers 102 and 110 include channel estimators 106 and 114, respectively. Channel estimator 114 can estimate the channel transform function matrix H for channels from transceiver 102 to transceiver 110 (e.g., the “downlink” channels in the example in which transceiver 102 is a BS and transceiver 110 is a UE), and channel estimator 106 can estimate the channel transform function matrix H′ for channels from transceiver 110 to transceiver 102 (e.g., the “uplink” channels). In one implementation, channel estimator 106 can estimate matrix H by solving Eqn. 2. For example, transceiver 102 can transmit “pilot” symbols from each of antennas 104.1, 104.2, and 104.3 to transceiver 110. For each antenna, these pilots are stored at transceivers 102 and 110 and can be transmitted over a number of time/frequency resources that are orthogonal to the time/frequency/code resources used by other antennas. Based on these pilot signals, channel estimator 114 can estimate channel transform function matrix H.

Transceiver 110 can feed this estimate of channel transform function matrix H to transceiver 102. Channel estimator 106 of transceiver 102 can then use the estimate of channel transform function matrix H to determine channel transform function matrix H′. In another implementation, channel estimator 106 can instead estimate matrix H′ by using pilot signals that are transmitted from each of antennas 112.1, 112.2, and 112.3.

FIG. 1 shows an example implementation in which transceiver 102 has three antennas, 104.1, 104.2, and 104.3. However, in other implementations, transceiver 102 may have a larger number of antennas. For example, in a massive-MIMO (M-MIMO) environment, transceiver 102 may have 100 or more antennas. In such an implementation, transmitting orthogonal pilot symbols from each antenna of transceiver 102 to allow for the estimation of channel transform function matrix H can require a very large amount of overhead. Moreover, explicit signaling of beamforming weights can waste resources especially in the case of a multiuser system in which transceiver 110 can serve multiple transceivers.

In embodiments described herein, an estimate of a channel transform function coefficient for a channel between first and second transceivers can be determined using a parametric model of the channel. For example, pilot signal(s) can be transmitted from the first transceiver to the second transceiver and used at the second transceiver to estimate parameter(s) of the parametric model.

In a further embodiment the parameter(s) can be applied to channels that have sufficiently similar characteristics such that the parameter(s) are applicable. Thus, the parametric model can be used to estimate the channel transform function matrix for channels from the first transceiver to the second transceiver. The use of a parametric model for a channel between first and second transceivers can allow for determining the channel transform function matrix with fewer than one pilot signal per channel. Thus, in an M-MIMO environment, the overhead needed to estimate the channel transform function matrix can be reduced.

In an embodiment, the first transceiver can determine the parametric model through a combination of determining a theoretical response of an antenna array of the first transceiver and calibration. The theoretical response of the antenna array can depend, e.g., on the geometry of the array. Calibration can be done, for example, by measuring signals received from the antenna array at different angles after the transceiver has been manufactured and/or when the first transceiver is deployed in the field. The first transceiver can disseminate this model to the second transceiver and other devices located within the communication range of the first device.

The second transceiver can feed the estimate of the channel transform function matrix back to the first transceiver. The first transceiver can use this information to determine an estimate for the channel transform function matrix for channels from the second transceiver to the first device. In an embodiment, the first transceiver can be a base station and the second transceiver can be a user equipment (UE).

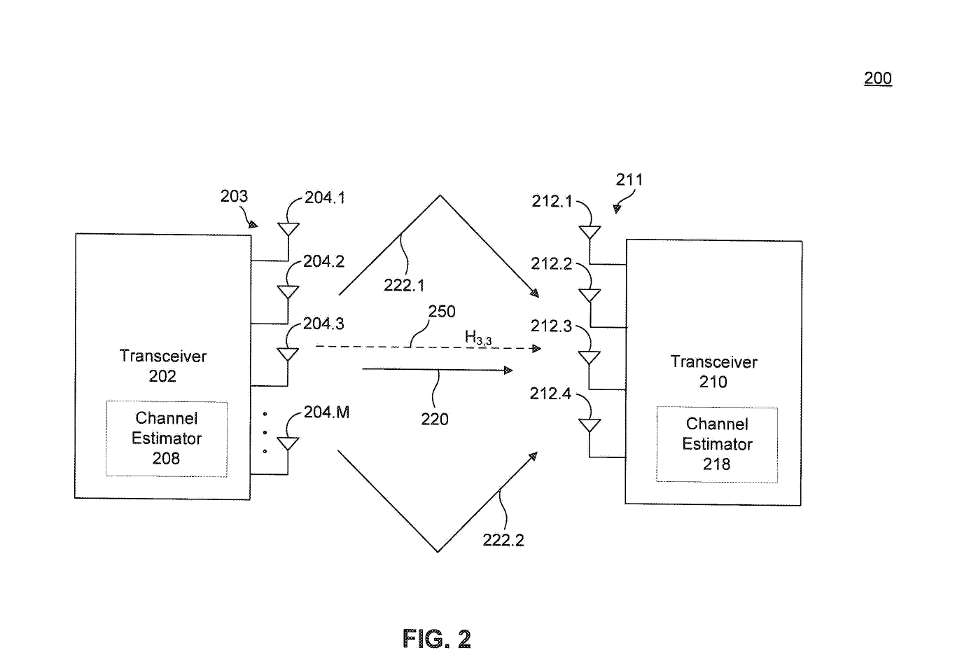

FIG. 2 shows a diagram of a communication environment 200, according to an embodiment. As shown in FIG. 2, communications environment 200 includes transceivers 202 and 210. In an embodiment, transceiver 202 can be a BS and transceiver 210 can be a UE. Transceiver 202 has an antenna array 203 including four antennas 204.1, 204.2, 204.3, and 204.4 (collectively referred to as antennas 204). Transceiver 210 has an antenna array including N antennas 212.1, 212.2, 212.3, . . . , 212.N (collectively referred to as antennas 212).

A communication channel exists between each antenna of antennas 204 and each antenna of antennas 212. For example, in FIG. 2, channel 250 illustrates a communication channel from antenna 204.3 to antenna 212.3. Communication received through a channel is a result of radiation received over a number of different paths. For example, as shown in FIG. 2, communication channel 250 includes radiation that travels over a line of sight (LoS) path 220 and radiation that travels through reflected paths 212.1 and 222.2.

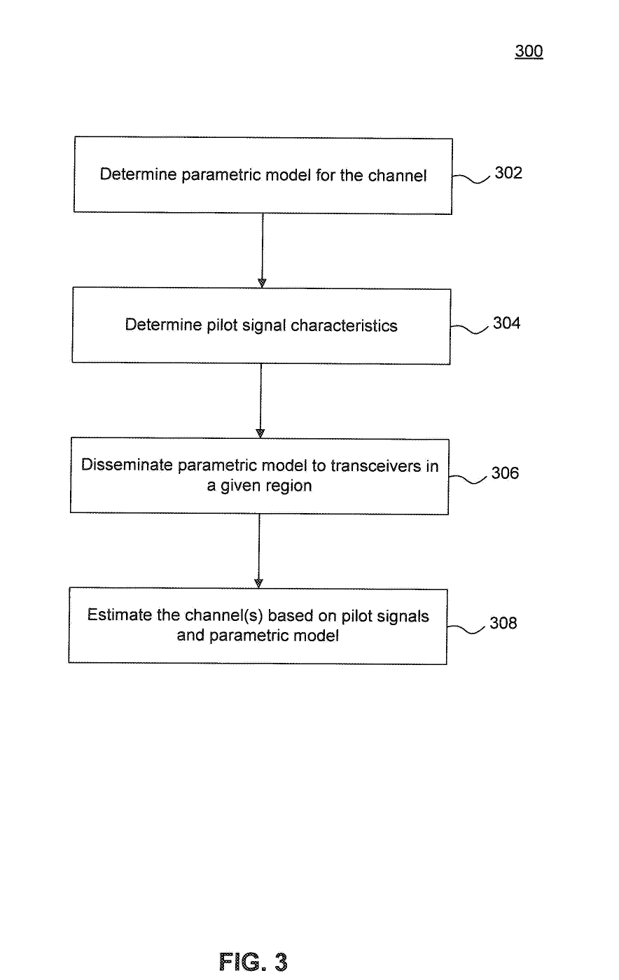

Transceivers 202 and 210 include channel estimators 208 and 218, respectively. For example, channel estimator 218 can be used to estimate the channel transform function matrix H, including coefficient H_{3,3} that characterizes channel 250. Transceiver 210 can then feed this information back to transceiver 202. Channel estimation module 208 can use this estimate to estimate the channel transform function matrix H′ characterizing communications from transceiver 210 to transceiver 202. The operation of transceivers 202 and 210 will be described in greater detail with respect to the flowchart shown in FIG. 3.

FIG. 3 shows a channel estimation method 300, according to an embodiment. Not all steps of method 300 may be required, nor do all of the steps shown in FIG. 3 necessarily have to occur in the order shown. Method 300 is described with respect to the embodiment shown in FIG. 2, but is not limited to that embodiment. For example, steps 302-306 can be performed at a BS and step 308 can be performed at a UE.

In step 302, a parametric model for a channel is determined. For example, in FIG. 2, channel estimator 208 can determine a parametric model for channel 250. In a further embodiment, all channels between transceiver 202 and transceiver 210 can be modeled using the same parametric model.

A parametric model can be a model that depends on the sum of a function, which itself depends on one or more parameters. For example, a parametric model, M can generally be expressed as:

M=Σⱼ₌₁^{N}F(∝_{1,j}, . . . ,∝_{i,j}, . . . ,∝_{1,j}), (Eqn. 3)

where:

∝_{i,j} is the jth value of the ith parameter, and

F( ) is a function whose value depends on the parameters.

In an embodiment, a parametric model can be used to model a channel between first and second devices. For example, parameters can be used to express characteristics of the communication channel. In the embodiment of FIG. 2, channel 250 can be modeled using a parametric model based on the different paths that make up channel 250. For example, a parametric model for communications between first and second devices can be expressed as:

H=Σⱼ₌₁^{N}∝ⱼW(θⱼ,φⱼ), (Eqn. 4)

where:

H is the estimate of the channel transfer function coefficient for channel 250,

∝ⱼ is a complex amplitude of a jth path between the transceivers 202 and 210,

W( ) is an array manifold associated with an antenna array of transceiver 202,

θⱼ is an azimuth angle of the jth path, and

φⱼ is an elevation angle of the jth path.

In the embodiment shown in FIG. 2, N, e.g., the number of paths, is 3. Thus, channel 250 is modeled as a sum of signals received over three different paths. The number of paths, N, can be a configurable aspect of the determined parametric model, which can depend on the physical characteristics of the channel. Ideally the number of paths between two antennas is infinite. However, as the number of paths, N increases, transceiver 210 may have to estimate a larger number of parametric values. Thus, estimating the number of paths, N, may require a balancing of the accuracy of the model and the resources needed to determine the parameter values. For example, in environments with few obstructions between transceivers 202 and 210, the LoS path between transceivers 202 and 210 can be substantially dominant, and the number of paths can be relatively small (e.g., 1 or 3). In environments with a relatively large number of obstructions, e.g., where there are multiple reflections between transceivers 202 and 210, N, can be relatively large.

When the parametric model of a channel is expressed using Eqn. 4, determining the parametric model for a particular channel can also include determining the array manifold W( ). The array manifold W( ) can be determined using a combination of theoretical modeling and calibration at manufacture and/or in the field. For example, the geometry of the array of transceiver 202, including antennas 204.1-204.M, can be used to model a response at different angles θ and φ. For example, full wave electromagnetic modeling software can be used to model the theoretical response of antenna array 211 at different angles.

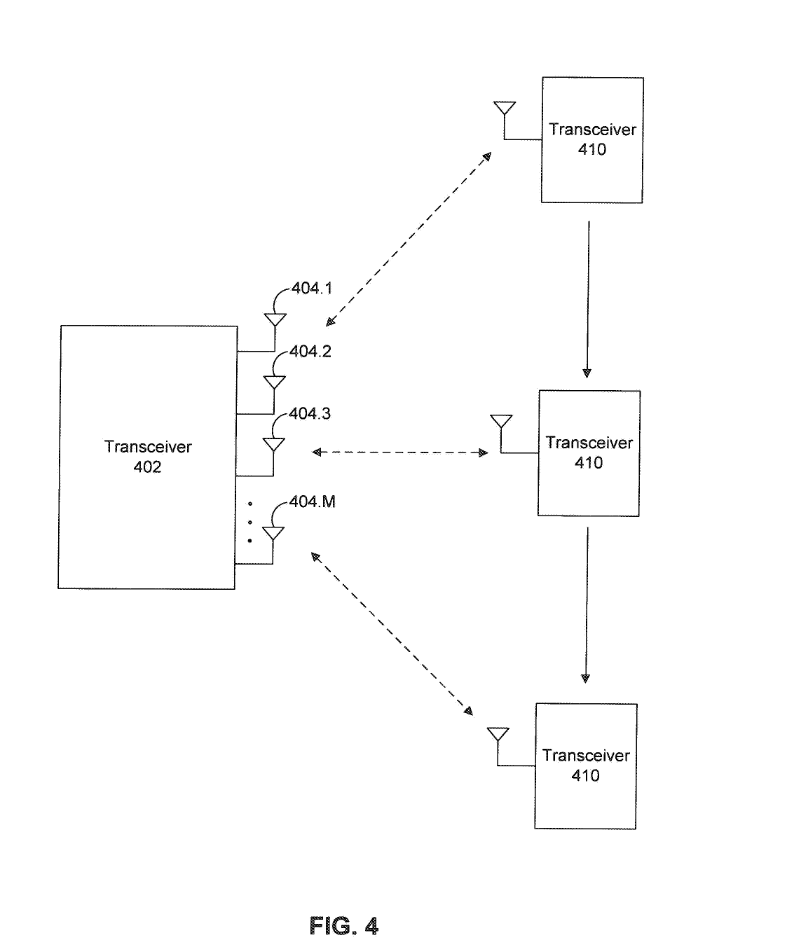

Moreover, calibration in the factory, and/or in the field can be used to calculate deviations in the response of antenna array 211, as manufactured, from the theoretical model. For example, in FIG. 4, transceiver 402 has an antenna array 403 including antennas 404.1, 404.2, 404.3, . . . , 404.M. The theoretical response of this antenna array can be modeled based on the designed geometry of antenna array 403 to determine an array manifold W( ). Antenna array 403 can be calibrated after it is manufactured to modify array manifold W( ) to capture variations of the geometry of antenna array 403 from its designed geometry. Furthermore, once transceiver 402 is deployed in the field, transceiver 410 can be moved to different locations to measure the response at different angles. For example, as shown in FIG. 4, transceiver 410 can be moved between three different elevation angles to measure the antenna arrays response.

Moreover, during field testing, the number of paths N can be assessed. For example, transceiver 410 can assess how reflective a given environment is and determine N accordingly. In an embodiment, transceiver 410 can determine whether radiation received from transceiver 402 is spread out over a large range of angles (indicating that the number of paths is relatively large) or confined to a smaller number of angles (indicating the opposite).

In an embodiment, the parametric model can be repeatedly determined. For example, in the embodiment of FIG. 2, transceiver 202 can continually determine the parametric model based on channel measurements received at transceiver 202. For example, transceiver 202 can periodically make measurements regarding the transmission characteristics of an area over which transceiver 202 can transmit and receive signals, e.g., fading characteristics, presence of obstructions, and/or presence of noise or interference. Transceiver 202 can also use information about the channel transmitted by transceiver 204. In another embodiment, transceiver 202 can determine a parametric model when transmission characteristics have been changed. For example, if an obstruction is created near transceiver 202, e.g., a new building is built, transceiver 202 can determine a parametric model that takes into account the added obstruction.

In step 304, pilot signal characteristics are determined. Pilot signal characteristics can include, for example, training symbols used in each pilot signal and/or antennas in an antenna array that will transmit pilot signals.

For example, in FIG. 2, transceiver 202 can determine which antennas 204 of antenna array 203 will transmit pilot signals to transceiver 210. In an embodiment, the minimum number of pilot signals transmitted from transceiver 202 to transceiver 210 is equal to the number of parameter values in the model. For example, when a channel is modeled according to Equation 2, the number of parameters that characterize a path (e.g., ∝, 0, φ) multiplied with the number of paths, N. However, additional pilot signals can be transmitted to increase the accuracy with which parameters are determined for a given channel.

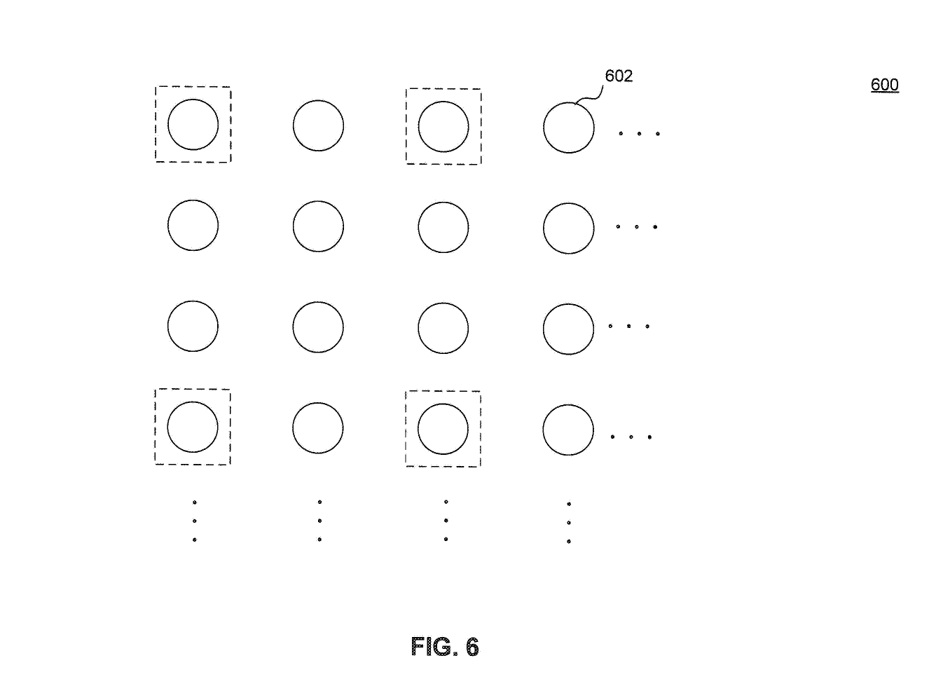

For example, FIG. 6 shows a diagram of an array 600, according to an embodiment. In an embodiment, antennas 204 of transceiver 202 can be distributed as shown in FIG. 6. In FIG. 6, antennas from which a pilot signal is transmitted are indicated with a dotted box. In a further embodiment, additional pilot signals can be transmitted toward the ends of antenna array 600 to account for additional variations caused by edge effects in antenna arrays.

In an embodiment, a pilot signal can include training sequences. Training sequences can be beamformed with different beam forming patterns and subsets of beam forming patterns used for training can be time and frequency multiplexed. The symbols used in a training sequence can be determined based on the number of the pilot signals transmitted.

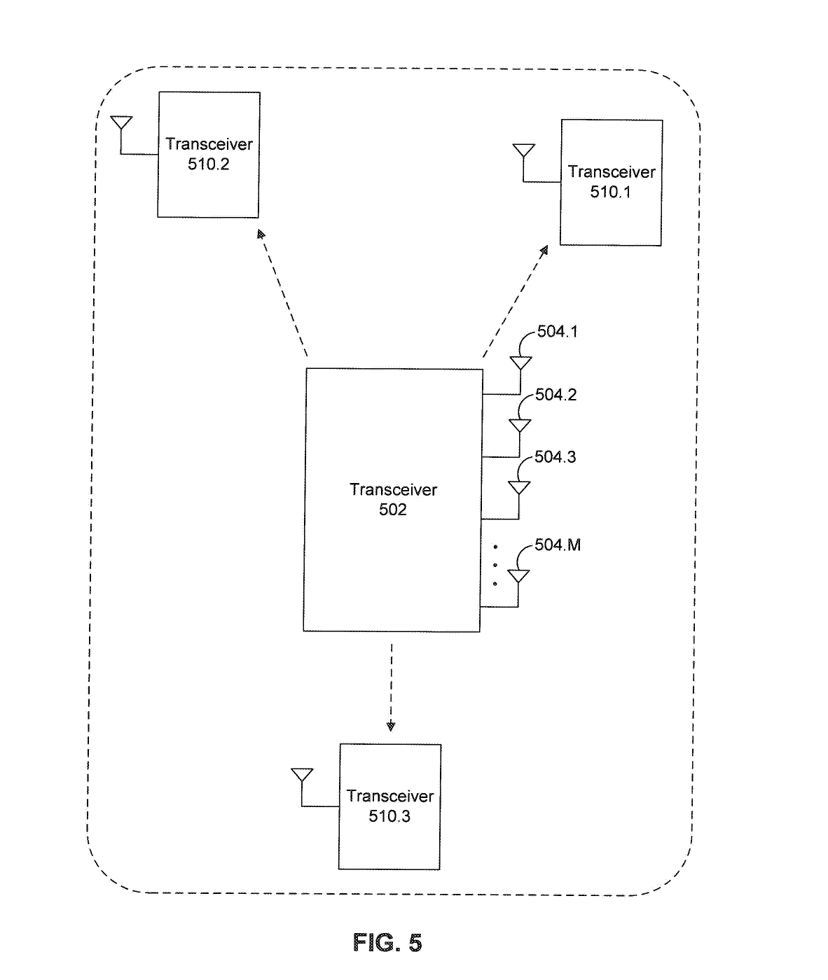

In step 306, the parametric model is disseminated to transceivers in a given region. For example, FIG. 5 shows an example in which a transceiver 502 transmits, or signals, the parametric model to all transceivers 510 included within a communication range of transceiver 502. For example, transceiver 502 can be a cellular base station and can transmit the parametric model to all transceivers located within the cell of transceiver 502. For example, in the embodiment in which communication channels are modeled using Equation 4, disseminating the parametric model can disseminating the array manifold W( ) and the number of paths, N.

In another embodiment, the parametric model can be disseminated by broadcasting the designed geometry of an antenna array and the observed deviation from the theoretical response of that geometry. For example, in the embodiment of FIG. 2, a parametric model can be disseminated by broadcasting the designed geometry of the antenna array of transceiver 202 and the observed deviation from the theoretical response of that geometry. Transceiver 212 can map the designed geometry to a stored array manifold and modify the array manifold based on the deviation.

The parametric model can be disseminated in a number of different ways. For example, in the embodiment in which transceivers 202 and 204 using the long term evolution (LTE) standard, transceiver 202 can disseminate the parametric model by including it in an LTE system information broadcast. As would be appreciated by those of ordinary skill in the art based on the disclosure herein, LTE system information broadcast include information such as cell access parameters and timing information, and can be broadcasted by a BS periodically.

In a further embodiment, transmitting the parametric model can include transmitting the determined pilot signal characteristics. For example, in the embodiment of FIG. 2, transceiver 202 can transmit the pattern of antennas that are transmitting pilot signals and how the pilot signals vary in time to transceiver 210. For example, transceiver 202 can transmit a bitmap that is used to describe pilot positions and antennas used for each position. In a further embodiment, transceiver can convey a pilot scheme used in a single transmission and in subsequent transmission indicate an offset relative to that pilot scheme.

In step 308, the channels are estimated based on the pilot signals and the parametric model. For example, channel estimation module 218 of transceiver 210 can use the pilot signals and received characteristics of the pilot signals (e.g., a bitmap describing which antennas transmitted pilot signals) to determine the parameters for each of the channels received at transceiver 210. Channel estimator 218 can then use the determine parameters to estimate the channel transformation values for each channel received at transceiver 210.

For example, and as described in greater detail below, if the channels received at transceiver 210 are modeled using Eqn. 4, channel estimator 218 can use pilot signals to determine parameter values for α, θ and φ for each of the N paths that make up the model of channel 250 and use these values to calculate a particular channel transfer function coefficient. Transceiver 210 can then feed this information back to transceiver 202. Transceiver 202 can estimate channels received at transceiver 202 by mapping the received information to channel transfer function coefficients for channels received at transceiver 202.

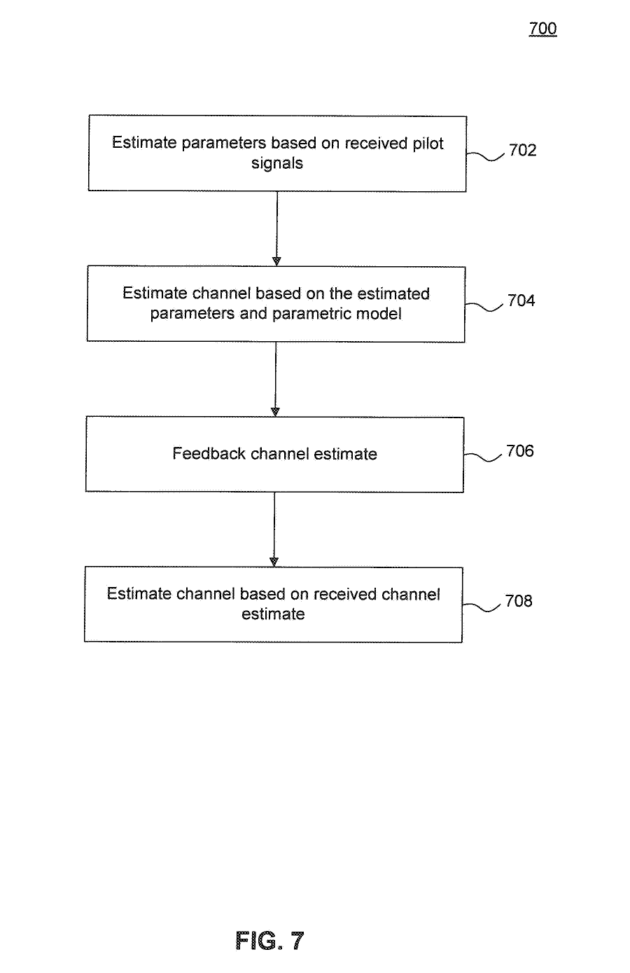

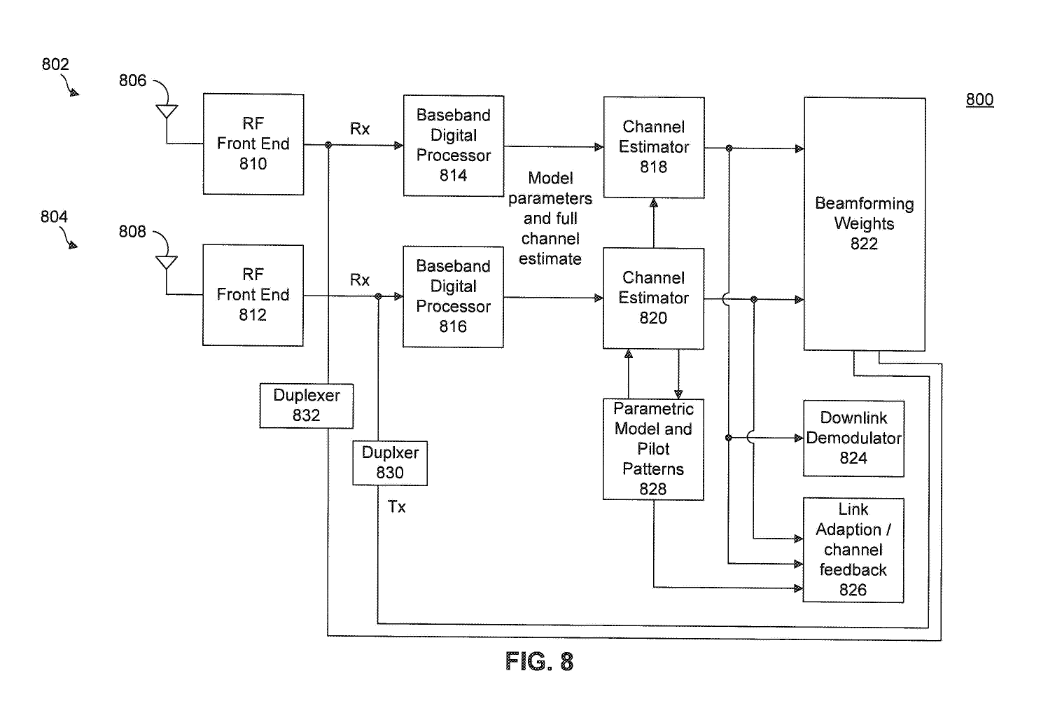

FIG. 8 shows a block diagram of a transceiver 800, according to an embodiment. In an embodiment, transceiver 202 and/or transceiver 210 can be implemented as transceiver 800. In a further embodiment, transceiver 800 can be a UE. As shown in FIG. 8, transceiver 800 includes receive paths 802 and 804. Receive path 802 includes a radio frequency (RF) front end 810, a baseband digital processor 814, and a channel estimator 818. Receive path 804 includes an antenna 808, an RF front end 812, a baseband digital processor 816, and a channel estimator 820. Transceiver 800 also includes a beam forming weights module 822, a demodulator 824, link adaption module 826, parametric model and pilot patterns module 828, and duplexers 830 and 832. The operation of transceiver 800 will be described in greater detail with respect to the flowcharts shown in FIG. 7.

FIG. 7 shows a flowchart of a method 700 for estimating channels between first and second devices, according to embodiment. Not all steps of method 700 may be required, nor do all of the steps shown in FIG. 7 necessarily have to occur in the order shown. Method 700 is described with respect to the embodiments shown in FIGS. 2 and 8, but is not limited to those embodiments.

In step 702, parameters of a parametric model are estimated based on received pilot signals. For example, in the embodiment in which Eqn. 4 is used to model a channel, parameters α, θ and φ for each path can be estimated by channel estimation module 218. For example, the received pilot signals can be used to estimate channel transfer function coefficients for specific channels between transceiver 202 and transceiver 210.

For example, in FIG. 8, antennas 806 and 808 can receive pilot signals from a transmitting device (e.g., a BS). In an embodiment, the pilot signals can include training symbols and/or pilot tones. The training symbols or pilot signals can be transmitted separately from data streams or multiplexed within data streams. Antennas 806 and 808 convert the received electromagnetic signals into respective analog electrical signals. RF front ends 810 and 812 receive the analog electrical signals and convert them to digital, baseband signals. RF front ends 810 and 812 can be implemented according to various different architectures known to those skilled in the art. Baseband digital processors 814 and 816 preform various signal processing (e.g., demodulation and decoding) on the baseband digital signals, and output respective signals to channel estimators 818 and 820.

Channel estimators 818 and 820 receive the processed signals as well as the parametric model and the pilot patterns used at the transmitting device. For example, as noted above, the transmitting device (e.g., transceiver 202) can disseminate the parametric model to all devices included in the transmission range of the transmitting device. Moreover, the pilot patterns used in channel estimation can be a predetermined sequence of training symbols and/or pilot tones known at the transmitting and receiving device. Channel estimators 818 and 820 can use the known pilot pattern and the processed signals to estimate channel transform function coefficients for channels received at antennas 806 and 808. For example, as would be appreciated by those of ordinary skill in the art based on the description herein, channel estimators 818 and 820 can use known least squares and/or minimum mean square error techniques for estimating the channel transform function coefficients.

Based on the estimated channel transform function coefficients, channel estimators 818 and 820 can estimate parameter values for parametric model. For example, if the channels are modeled using Eqn. 4, channel estimators 818 and 820 can use known algebraic techniques to solve for the parameter values based on the channel transform function coefficients. In general, to solve a system of algebraic equations, the number of equations must be at least equal to the number of variables. Thus, in the embodiment of FIG. 8, the channel transform function coefficients can be used with other channel transform determined at different antennas based on other pilot signals to create a system of equations, which can be solved for the parameter values.

In a further embodiment, it can be predetermined that certain channels have relatively similar values for certain parameters. For example, a certain subset of antennas may have a relatively similar α, θ and/or φ for a particular path. For example, based on the geometry of transmitting and/or receiving antenna array, it can be determined that a certain subset of antennas have relatively similar elevation angles θ for the N=1 (e.g., a reflection path). Thus, the same value of elevation angles θ, determined from a pilot signal for a particular one of the subset, can be applied to the entire subset (for the N=1 path).

In step 704, a channel is estimated based on the parameters in the parametric model. For example, the parametric model can be used to estimate the channel transform function coefficients for channels for which a pilot signal was not transmitted. For example, in FIG. 2, in the embodiment that a pilot signals was not transmitted for channel 250, the estimated a, 0 and/or go values for paths 220, 222.1, and 222.2, can be used to calculate an estimate for channel 250 using Eqn. 4. Step 704 can be repeated for each channel received at transceiver 210 for which a pilot signal was not transmitted to estimate the channel transfer function matrix.

In step 706, the channel estimate is fed back to the first device. For example, in FIG. 2, transceiver 210 can feed back the channel transfer function matrix to transceiver 202. For example, transceiver 210 can use a channel code book that is tuned to the determined parametric model to feedback the channel information. For example, transceiver 210 can feed back the parameters of the model that can be used to calculate the channel estimates at transceiver 202. In such a manner, the amount of information transmitted from transceiver 210 to transceiver 202 can be compressed.

For example, as shown in FIG. 8, link adaption/channel feedback module 826 can receive the estimated parameters, the parametric model, and/or the channel transform function matrix and can feed this information back to the transmitting device. For example, link adaption/channel feedback module 826 can formulate a signal including the estimated parameters, the parametric model, and/or the channel transform function matrix and use transmit resources in transceiver 800 to send the signal back to the original transmitting device.

In step 708, a second channel can be estimated based on the received channel estimate. For example, in FIG. 2, channel estimator 208 can estimate channels from transceiver 202 to transceiver 210 based on the received channel estimate from transceiver 210. For example, channel 208, assuming that channels between transceivers 202 and 210 have reciprocity, can map the estimated channel transfer function matrix to another channel transfer function matrix for the channels from transceiver 210 to transceiver 202. For example, in the embodiment of FIG. 8, the original transmitting device can use the estimated parameters, the parametric model, and/or the channel transform function matrix transmitted using link adaption/channel feedback module 826 to estimate one or more channels.

To employ channel reciprocity, transceiver 202 and/or transceiver 210 can perform transmit and receive calibration. In general, physical channels between devices can be reciprocal, but the circuitry included in transceivers 202 and 210 may not be strictly identical. Transmit and receive calibration can be used to account for this difference.

In an alternate embodiment, a transceiver can use pilot signal(s) to estimate the second channel. For example, in the embodiment of FIG. 2, transceiver 202 can estimate channels based on pilot signals received from transceiver 210. For example, transceiver 202 can perform steps 702-706 using the disseminated parametric model and pilot signals transmitted from transceiver 210.

In an embodiment, the channel transform function coefficient, the parameter values, and the parametric model can be used to determine beam forming weights. For example, in FIG. 8, channel estimators 818 and 820 output the estimated parameters, the parametric model, and/or the channel transform function coefficients to beam forming weights module 822, which can calculate beam forming weights for signals transmitting from transceiver 800. As shown in FIG. 8, duplexers 830 and 832 can use these beam forming weights in generating symbols to be transmitting via RF front ends 810 and 812 and antennas 806 and 808. Beam forming weights can be applied to symbols to be transmitted (not shown in FIG. 8) before being transmitted by transceiver 800.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A method of channel estimation, comprising:
determining, in a first transceiver, a parametric model for a channel between the first transceiver and a second transceiver; and
transmitting a pilot signal to the second transceiver, wherein the second transceiver is configured to determine a parameter of the parametric model based at least on the pilot signal and to estimate a channel transfer function coefficient for the channel based on the parameter and the parametric model.

2. The method of claim 1, further comprising:
disseminating the parametric model and a characteristic of the pilot signal from the first transceiver to the second transceiver.

3. The method of claim 2, wherein the disseminating comprises:
transmitting a response of an antenna array of the first transceiver to the second transceiver.

4. The method of claim 2, wherein the disseminating comprises:
signalling a geometry of an antenna array of the first transceiver and a deviation from a theoretical response associated with the geometry to the second transceiver.

5. The method of claim 1, wherein the parameter is at least one of a complex amplitude associated with a path between the first and second devices, an azimuth angle of the path, or an elevation angle of the path.

6. The method of claim 1, wherein the parametric model is expressed as
H=Σⱼ₌₁^{N}∝ⱼW(θⱼ,φⱼ), wherein:
H is the estimate of the channel transfer function coefficient,
∝ⱼ is a complex amplitude of a jth path between the first and second devices,
W( ) is an array manifold associated with an antenna array of the first device,
θⱼ is an azimuth angle of the jth path, and
φⱼ is an elevation angle of the jth path.

7. The method of claim 1, wherein the determining comprises:
determining a theoretical response of an antenna array of the first transceiver.

8. The method of claim 1, wherein the determining comprises:
calibrating an antenna array of the first transceiver at a plurality of azimuth angles and at a plurality of elevation angles.

9. The method of claim 1, further comprising:
selecting an antenna of an antenna array of the first transceiver to transmit the pilot signal.

10. The method of claim 1, wherein the transmitting comprises:
transmitting a plurality of pilot signals to the second transceiver, the plurality of pilot signals including the pilot signal, the method further comprising:
selecting a plurality of antennas of an antenna array of the first transceiver to transmit the plurality of pilot signals; and
transmitting a signal that identifies the plurality of antennas to the second transceiver.

11. The method of claim 1, further comprising:
receiving the parameter from the second transceiver.

12. The method of claim 1, further comprising:
estimating a channel transfer function coefficient for a second channel between the first and second transceivers.

13. The method of claim 12, wherein the estimating comprises:
receiving a second pilot signal from the second transceiver;
determining a second parameter of the parametric model based on the second pilot signal.

14. The method of claim 12, wherein the estimating comprises:
mapping a received channel estimate to a channel estimate for the second channel.

15. The method of claim 1, wherein the parametric model is expressed as a complex weighted sum of two or more antenna array manifolds.

16. A method of channel estimation, comprising:
receiving at a second transceiver, a parametric model from a first transceiver:
receiving a pilot signal from the first transceiver;
determining a parameter of a parametric model of a channel between the first transceiver and the second transceiver based on the received pilot signal; and
estimating, at the second transceiver, a channel transfer function coefficient for the channel based at least on the parameter and the parametric model.

17. (canceled)

18. The method of claim 16, wherein the receiving comprises:
receiving a geometry of an antenna array of the first transceiver.

19. The method of claim 16, wherein the parametric model is expressed as:
H=Σⱼ₌₁^{N}∝ⱼ∝ⱼW(θⱼ,φⱼ), wherein:
H is the estimate of the channel transfer function coefficient,
∝ⱼ is a complex amplitude of a jth path between the first and second transceivers,
W( ) is an array manifold associated with an antenna array of the first transceiver,
θⱼ is an azimuth angle of the jth path, and
φⱼ is an elevation angle of the jth path.

20. The method of claim 16, further comprising:
transmitting the estimate of the channel transfer function coefficient to the first transceiver.

21. The method of claim 16, wherein the parametric model is expressed as a complex weighted sum of two or more antenna array manifolds.
